(19) United States
(12) Patent Application Publication
(10) Pub. No.: US 2019/0318328 A1
(43) Pub. Date: Oct. 17, 2019

(54) REAL-TIME DATA PROCESSING PLATFORM WITH INTEGRATED COMMUNICATION LINKAGE

(71) Applicant: BANK OF AMERICA CORPORATION, Charlotte, NC (US)

(72) Inventors: Joseph Benjamin Castinado, North Glenn, CO (US); Charles Russell Kendall, Snoqualmie, WA (US)

(21) Appl. No.: 15/952,039

(22) Filed: Apr. 12, 2018

(51) Int. Cl. G06Q 20/08; G06Q 20/06; G06Q 20/02; G06Q 20/22; G06Q 20/38; H04L 9/06

(52) U.S. Cl. CPC G06Q 20/0855; G06Q 20/06; G06Q 20/023; H04L 67/104; G06Q 20/382; H04L 9/0637; G06Q 20/223

(57) ABSTRACT

A real-time data processing platform is provided comprising, a controller configured for accessing and extracting information from across a distributed ledger of at least one block chain defined by a plurality of nodes participating on the at least one block chain. The platform further comprises a processing device is configured to complete a first interaction between a first user and a second user in substantially real-time. The platform establishes an operable communication linkage with at least some of the plurality of nodes of the block chain and extracts detailed interaction information associated with the first interaction from the distributed ledger. A first message is generated, wherein the detailed interaction information is integrated into the first message. The platform transmits the first message to a first user device associated with the first user.

### BACKGROUND

With the development of improved rapid interaction completion systems, there exists a need for a rapid data processing method that leverages block chain architecture to extract and collect available, recorded information and present it to a user in a convenient, integrated format, wherein the user may view a full life-cycle of an available data record.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method and computer program product for providing a real-time data processing platform with integrated communication linkages. The invention may be exampled by a real-time data processing platform which defines a specific embodiment of the invention. The system typically comprises: a plurality of nodes defining at least one block chain, the at least one block chain comprising a distributed ledger; and a controller configured for accessing and extracting information from across the distributed ledger, the controller comprising a memory device with computer-readable program code stored thereon, a communication device in communication with a network, and a processing device operatively coupled to the memory device and the communication device, wherein the processing device is configured to execute the computer-readable program code to: complete a first interaction between a first user and a second user in substantially real-time; establish an operable communication linkage with at least some of the plurality of nodes of the block chain; extract detailed interaction information associated with the first interaction from the distributed ledger; generate a first message, wherein the detailed interaction information is integrated into the first message; and transmit the first message to a first user device associated with the first user.

In one embodiment, the detailed interaction information comprises information associated with a second interaction between the second user and a third user, wherein the second interaction is associated with the first interaction.

In another embodiment, the processing device is further configured to: execute a search of the distributed ledger for one or more additional interactions associated with the first interaction; extract additional detailed interaction information associated with the one or more additional interactions; and present the additional detailed information to the first user.

In yet another embodiment, the additional detailed interaction information associated with the one or more additional interactions provides a full life-cycle of the one or more additional interactions, wherein the full life-cycle provides a complete temporal progression of the one or more additional interactions. In yet another embodiment, the additional detailed interaction information is extracted from across a plurality of block chains.

In yet another embodiment, the detailed interaction information comprises location information associated with the first transaction.

In yet another embodiment, at least one smart contract is configured to complete the first interaction and extract the detailed interaction information from the distributed ledger, wherein completion of the first interaction by the smart contract is triggered by fulfillment of one or more predetermined conditions set by at least one of the first user and the second user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a real-time interaction communication system environment, in accordance with one embodiment of the invention;

FIG. 2 provides a block diagram of a user device, in accordance with one embodiment of the invention;

FIG. 3 provides a block diagram of a real-time interaction system, in accordance with one embodiment of the invention;

FIG. 4 provides a block diagram of a block chain distributed network system, in accordance with one embodiment of the invention;

FIG. 5 provides a block diagram of a high-level real-time interaction flow environment, in accordance with one embodiment of the invention;

FIG. 6A provides a centralized database architecture environment, in accordance with one embodiment of the invention;

FIG. 6B provides a high level block chain system environment architecture, in accordance with one embodiment of the invention;

FIG. 7 provides a high level process flow illustrating node interaction within a block chain system environment architecture, in accordance with one embodiment of the invention; and

FIG. 8 provides a high level process map illustrating the implementation of a real-time interaction communication system, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

As used herein, the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), personal digital assistant (PDA), a mobile Internet accessing device, or other mobile device. Other types of mobile devices may include portable digital assistants (PDAs), pagers, wearable devices, mobile televisions, gaming devices, laptop computers, cameras, video recorders, audio/video player, radio, global positioning system (GPS) devices, or any combination of the aforementioned. In some embodiments, a device may refer to an entity's computer system, platform, servers, databases, networked devices, or the like. The device may be used by the user to access the system directly or through an application, online portal, internet browser, virtual private network, or other connection channel. The device may be a computer device within a network of connected computer devices that share one or more network storage locations.

As used herein, the term “computing resource” or “computing hardware” may be used to refer to elements of one or more computing devices, networks, or the like available to be used in the execution of tasks or processes. A computing resource may include processor, memory, network bandwidth and/or power used for the execution of tasks or processes. A computing resource may be used to refer to available processing, memory, and/or network bandwidth and/or power of an individual computing device as well a plurality of computing devices that may operate as a collective for the execution of one or more tasks (e.g., one or more computing devices operating in unison or nodes of a distributed computing cluster).

A “user” as used herein may refer to any entity or individual associated with the real-time data processing platform. In some embodiments, a user may be a computing device user, a phone user, a mobile device application user, a financial institution customer (e.g., an account holder or a person who has an account (e.g., banking account, credit account, or the like)), a system operator, database manager, a support technician, and/or employee of an entity. In some embodiments, identities of an individual may include online handles, usernames, identification numbers (e.g., Internet protocol (IP) addresses), aliases, family names, maiden names, nicknames, or the like. In some embodiments, the user may be an individual or an organization (i.e., a charity, business, company, governing body, or the like).

In accordance with embodiments of the invention, the term “entity” may be used to include any organization or collection of users that may interact with the system. An entity may refer to a business, company, or other organization that either maintains or operates the system or requests use and accesses the system. The terms “financial institution” and “financial entity” may be used to include any organization that processes financial transactions (e.g., a transfer of funds or other monetary or financial resources) including, but not limited to, banks, credit unions, savings and loan associations, investment companies, stock brokerages, asset management firms, insurance companies and the like. In specific embodiments of the invention, use of the term “bank” is limited to a financial entity in which account-bearing customers conduct financial transactions, such as account deposits, withdrawals, transfers and the like. In other embodiments, an entity may be a business, organization, a government organization or the like that is not a financial institution.

“Authentication information” is any information that can be used to identify a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing device, or the like to access, write, delete, copy, or modify data within at least a portion of the system.

To “monitor” is to watch, observe, or check something for a special purpose over a period of time. The “monitoring” may occur periodically over the period of time, or the monitoring may occur continuously over the period of time. In some embodiments, a system may actively monitor a database or data archive, wherein the system reaches out to the database and watches, observes, or checks the database for changes, updates, and the like. In other embodiments, a system may passively monitor a database, wherein the database provides information to the system and the system then watches, observes, or checks the provided information. In some embodiments a system, application, and/or module may monitor a user input into the system. In further embodiments, the system may store said user input during an interaction in order to substantially replicate said user input at another time.

As used herein, a “connection” or an “interaction” may refer to any communication between one or more users, one or more entities or institutions, and/or one or more devices, nodes, clusters, or systems within the system environment described herein. For example, an interaction may refer to a transfer of data between systems, devices, and/or application; an accessing of stored data by one or more devices; a transmission of a requested task; a reporting and correction of an error; or the like. In another example, an interaction may refer to a user interaction with a user device through a user interface in order to connect or communicate with an entity and/or entity system to complete an operation (e.g., request a transfer of funds from an account, complete a form, or the like). In another embodiment, an “interaction” may refer to a financial transaction executed between two or more users and/or entities.

As used herein, a “real-time interaction” refers to a resource transfer between users and/or entities participating in and leveraging a settlement network operating in real or near real-time (e.g., twenty-four hours a day, seven days a week), wherein settlement of the interaction occurs at or very close in time to the time of the interaction. A real-time interaction may include a payment, wherein a real-time interaction system enables participants to initiate credit transfers, receive settlement for credit transfers, and make available to a receiving participant funds associated with the credit transfers in real-time, wherein the credit transfer may be final and irrevocable. Real-time interactions or payments provide marked improvements over conventional interaction clearing and payment settlement methods (e.g., automated clearing house (ACH), wire, or the like) which can require several hours, days, or longer to receive, process, authenticate a payment, and make funds available to the receiving participant which may, in total, require several back-and-forth communications between involved financial institutions. In some cases, conventional settlement methods may not be executed until the end of the business day (EOB), wherein payments are settled in batches between financial institutions.

Real-time interactions reduce settlement time by providing pre-authentication or authentication at the time of a requested interaction in order to enable instantaneous or near-instantaneous settlement between financial institutions at the time of the interaction, wherein resources or funds may be made immediately available to a receiving participant (i.e., payee) following completion of the interaction. Examples of real-time interactions include business to business interactions (e.g., supplier payments), business to consumer interactions (e.g., legal settlements, insurance claims, employee wages), consumer to business interactions (e.g., bill pay, hospital co-pay, payment at point-of-sale), and peer to peer (P2P) interactions (e.g., repayment or remittance between friends and family). In a specific example, a real-time interaction may be used for payment of a utility bill on the due date of the bill to ensure payment is received on-time and accruement of additional fees due to late payment is avoided. In another example, real-time interactions may be especially beneficial for small entities and users (e.g., small merchants/businesses) that may have a heavier reliance on short-term funds and may not prefer to wait days for transaction settlements.

Real-time interactions not only provide settlement immediacy, but also provide assurance, fraud reduction, and bank-grade security to payments due to the inherent nature of the payment and user authentication infrastructure. Further, real-time interactions may reduce payment processing costs due to the simplified nature of required communication when compared to conventional settlement methods. In some embodiments, real-time interaction systems further include information and conversation tools that financial institutions may utilize to enhance a settlement experience for participants.

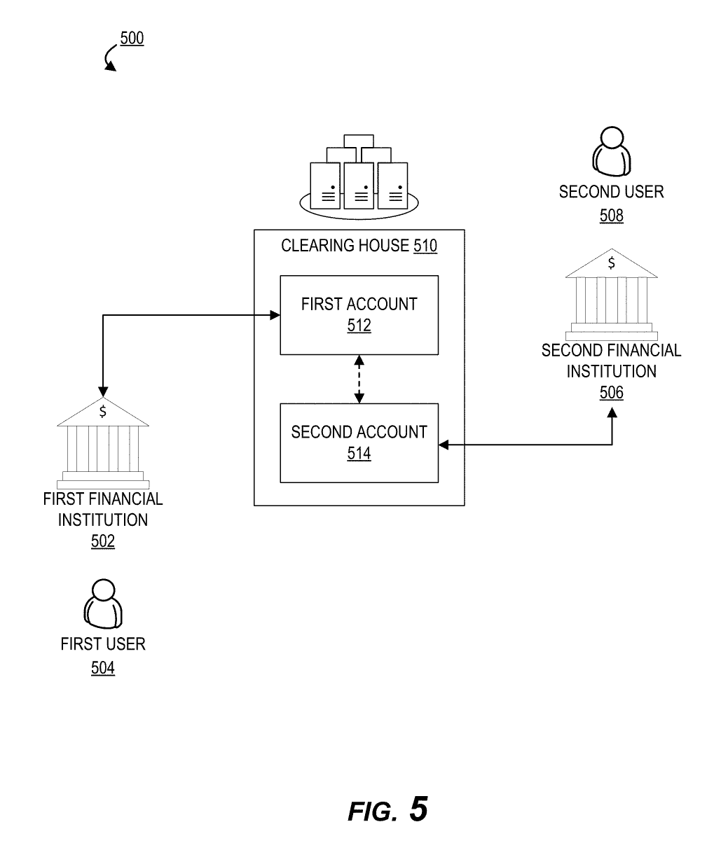

A system leveraging a real-time interaction settlement network allows for an interaction, transaction, payment, or the like to be completed between participating parties (e.g., financial institutions and/or their customers) via an intermediary clearing house acting in the role of a neutral party. Participant accounts are held at the clearing house and administered by both the participant and the clearing house. In this way, the clearing house is able to transfer resources or funds between the participant accounts on behalf of the participants in order to settle interactions. A real-time interaction settlement network is discussed in further detail with respect to FIG. 5.

Embodiments of the invention leverage block chain technology within a real-time payment environment in a nonconventional way to connect disparate systems and present a holistic view of a full interaction life-cycle to a user within a communication platform including a complete historical record of one or more interactions and related events and information. In this way, the invention further solves the technical problem of how to provide visibility into cross-organizational interactions (e.g. between separate financial institutions), wherein the organizations typically keep most, if not all, information private on secure systems. This level of improved transparency may illuminate beneficial account and transactional information and provide a holistic view of an interaction history. In a specific example, the shared information may reveal a reason for a participant's past credit transfer which may assist in further transactional decision-making involving the participant. The invention further extracts and integrates information from a distributed ledger of the block chain within a messaging application to provide an enhanced, user-facing platform incorporating the extracted information from the block chain.

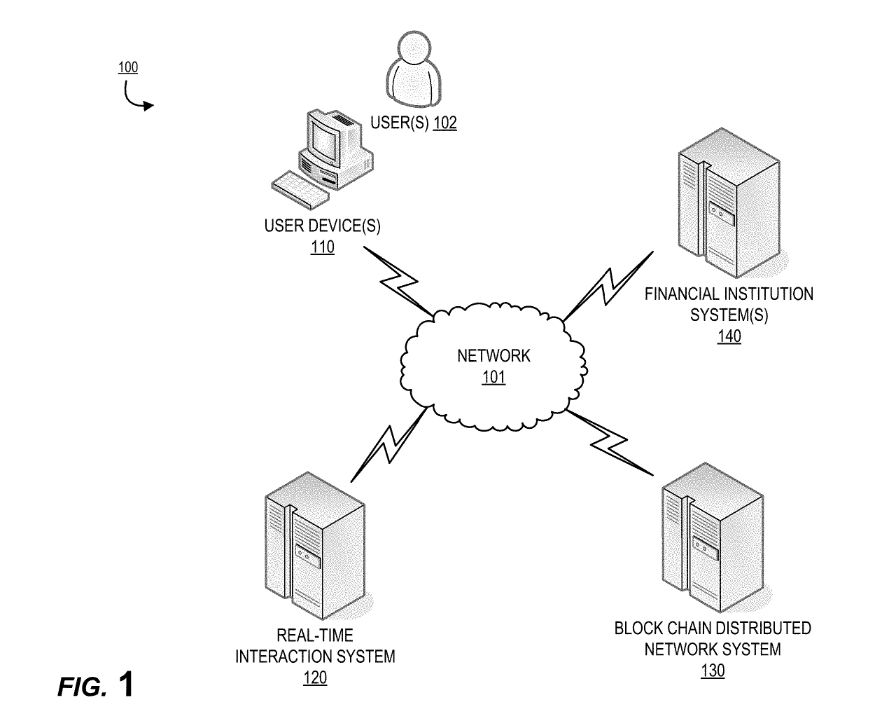

FIG. 1 provides a system that includes specialized systems and devices communicably linked across a distributive network of nodes required to perform the functions of implementing the real-time interaction communication system as described herein. FIG. 1 provides a real-time interaction communication system environment 100, in accordance with one embodiment of the present invention. As illustrated in FIG. 1, the real-time interaction system 120 is operatively coupled, via a network 101 to the user device 110, block chain distributed network system 130, and the financial institution system 140. In this way, the real-time interaction system 120 can send information to and receive information from the user device 110, the block chain distributed network system 130, and financial institution system 140. FIG. 1 illustrates only one example of an embodiment of the system environment 100, and it will be appreciated that in other embodiments one or more of the systems, devices, or servers may be combined into a single system, device, or server, or be made up of multiple systems, devices, or servers.

The network 101 may be a system specific distributive network receiving and distributing specific network feeds and identifying specific network associated triggers. The network 101 may also be a global area network (GAN), such as the Internet, a wide area network (WAN), a local area network (LAN), or any other type of network or combination of networks. The network 101 may provide for wireline, wireless, or a combination wireline and wireless communication between devices on the network 101.

In some embodiments, the user 102 is an individual, entity, or system that desires to implement the benefits of the real-time interaction and communication system over the network 101, such as by transmitting or receiving message and/or information related to one or more transactions. In some embodiments a user 102 is a user or entity completing a transaction leveraging a real-time interaction system (e.g., a payor or payee). In other embodiments, the user 102 is a user or entity managing data storage on the block chain. In some embodiments, the user 102 has a user device 110, such as a mobile phone, tablet, or the like that may interact with a device of another user and/or the systems and devices described herein to complete and/or record a transaction. In some embodiments, one or more of the devices and systems described herein may extract information or data from a distributed ledger stored on the block chain distributed network system 130.

It is understood that the servers, systems, and devices described herein illustrate one embodiment of the invention. It is further understood that one or more of the servers, systems, and devices can be combined in other embodiments and still function in the same or similar way as the embodiments described herein.

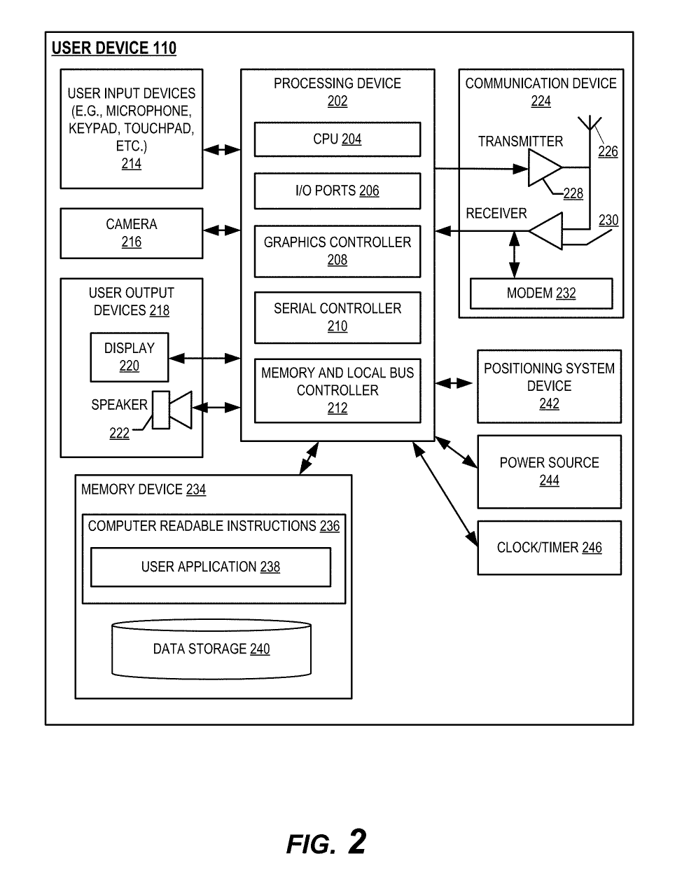

FIG. 2 provides a block diagram of a user device 110, in accordance with one embodiment of the invention. The user device 110 may generally include a processing device or processor 202 communicably coupled to devices such as, a memory device 234, user output devices 218 (for example, a user display device 220, or a speaker 222), user input devices 214 (such as a microphone, keypad, touchpad, touch screen, and the like), a communication device or network interface device 224, a power source 244, a clock or other timer 246, a visual capture device such as a camera 216, a positioning system device 242, such as a geo-positioning system device like a GPS device, an accelerometer, and the like, one or more chips, and the like. The processing device 202 may further include a central processing unit 204, input/output (I/O) port controllers 206, a graphics controller or GPU 208, a serial bus controller 210 and a memory and local bus controller 212.

The processing device 202 may include functionality to operate one or more software programs or applications, which may be stored in the memory device 234. For example, the processing device 202 may be capable of operating applications such as the user application 238. The user application 238 may then allow the user device 110 to transmit and receive data and instructions from the other devices and systems. The user device 110 comprises computer-readable instructions 236 and data storage 240 stored in the memory device 234, which in one embodiment includes the computer-readable instructions 236 of a user application 238. In some embodiments, the user application 238 allows a user 102 to access and/or interact with content provided from an entity. In some embodiments, the user application 238 further includes a client for messaging one or more other users and/or entities. The user application 238 may also allow the user to manage and view detailed information related to a plurality of past and/or pending interactions.

The processing device 202 may be configured to use the communication device 224 to communicate with one or more other devices on a network 101 such as, but not limited to the real-time interaction system 120. In this regard, the communication device 224 may include an antenna 226 operatively coupled to a transmitter 228 and a receiver 230 (together a “transceiver”), modem 232. The processing device 202 may be configured to provide signals to and receive signals from the transmitter 228 and receiver 230, respectively. The signals may include signaling information in accordance with the air interface standard of the applicable BLE standard, cellular system of the wireless telephone network and the like, that may be part of the network 201. In this regard, the user device 110 may be configured to operate with one or more air interface standards, communication protocols, modulation types, and access types. By way of illustration, the user device 110 may be configured to operate in accordance with any of a number of first, second, third, and/or fourth-generation communication protocols and/or the like. For example, the user device 110 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The user device 110 may also be configured to operate in accordance with non-cellular communication mechanisms, such as via a wireless local area network (WLAN) or other communication/data networks. The user device 110 may also be configured to operate in accordance Bluetooth® low energy, audio frequency, ultrasound frequency, or other communication/data networks.

The user device 110 may also include a memory buffer, cache memory or temporary memory device operatively coupled to the processing device 202. Typically, one or more applications 238, are loaded into the temporarily memory during use. As used herein, memory may include any computer readable medium configured to store data, code, or other information. The memory device 234 may include volatile memory, such as volatile Random Access Memory (RAM) including a cache area for the temporary storage of data. The memory device 234 may also include non-volatile memory, which can be embedded and/or may be removable. The non-volatile memory may additionally or alternatively include an electrically erasable programmable read-only memory (EEPROM), flash memory or the like.

Though not shown in detail, the system further includes a financial institution system 140 (as illustrated in FIG. 1) which is connected to the user device 110, the real-time interaction system 120, and the block chain distributed network system 130 and may be associated with one or more financial institutions or financial entities. In this way, while only one financial institution system 140 is illustrated in FIG. 1, it is understood that multiple, networked financial institution systems may be included in the system environment 100. The financial institution system 140 generally comprises a communication device, a processing device, and a memory device. The financial institution system 140 comprises computer-readable instructions stored in the memory device, which in one embodiment includes the computer-readable instructions of a financial institution application. The financial institution system 140 may communicate with the user device 110, the real-time interaction system 120, and the block chain distribute network system 130 to, for example, complete a real-time interaction.

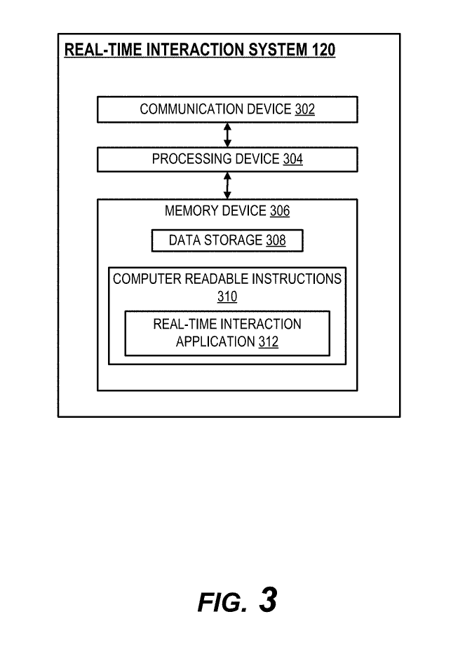

FIG. 3 provides a block diagram of the real-time interaction system 120, in accordance with one embodiment of the invention. The real-time interaction system 120 generally comprises a communication device 302, a processing device 304, and a memory device 306. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 306 is operatively coupled to the communication device 302 and the memory device 306. The processing device 304 uses the communication device 302 to communicate with the network 101 and other devices on the network 101, such as, but not limited to the user device 110, the block chain distributed network system 130, and the financial institution system 140. As such, the communication device 302 generally comprises a modem, server, or other device for communicating with other devices on the network 101.

As further illustrated in FIG. 3, the real-time interaction system 120 comprises computer-readable instructions 310 stored in the memory device 306, which in one embodiment includes the computer-readable instructions 310 of a real-time interaction application 312. In some embodiments, the memory device 306 includes data storage 308 for storing data related to the system environment, but not limited to data created and/or used by the real-time interaction application 312.

Embodiments of the real-time interaction system 120 may include multiple systems, servers, computers or the like maintained by one or many entities. FIG. 3 merely illustrates one of those systems that, typically, interacts with many other similar systems, such as the financial institution system 140, to complete and settle interactions in real-time. In some embodiments, financial institution systems 140 may be part of the real-time interaction system 120. Similarly, in some embodiments, the block chain distributed network system 130 is part of the real-time interaction system 120 or vice versa. The real-time interaction system 120 may communicate with the block chain distributed network system 130 and the financial institution system 140 via a secure connection generated for secure encrypted communications between the systems.

In one embodiment of the real-time interaction system 120, the memory device 306 stores, but is not limited to, a real-time interaction application 312. In one embodiment of the invention, the real-time interaction application 312 may associate with applications having computer-executable program code that instructs the processing device 304 to operate the network communication device 302 to perform certain communication functions described herein. In one embodiment, the computer-executable program code of an application associated with the real-time interaction application 312 may also instruct the processing device 304 to perform certain logic, data processing, and data storing functions of the application.

The processing device 304 is configured to use the communication device 302 to gather data, such as data corresponding to transactions or interactions from various data sources such as the block chain distributed network system 130. The processing device 304 stores the data that it receives in the memory device 306. The memory device may further comprise stored user account information (e.g., account number, routing number, user identifying information, etc.). In some embodiments, the real-time interaction system may include a controller configured to interact with the one or more other systems of the environment 100 (e.g., access and extract data), wherein the controller may be used to execute the one or more steps and processes described herein.

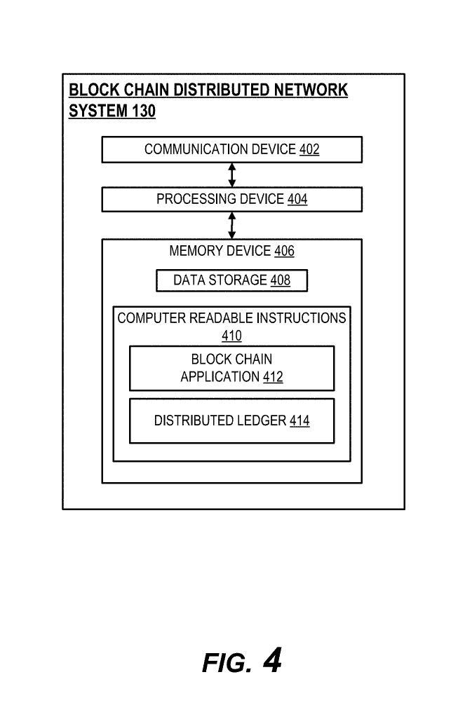

FIG. 4 provides a block diagram of the block chain distributed network system 130, in accordance with one embodiment of the invention. The block chain distributed network system 130 generally comprises a communication device 402, a processing device 404, and a memory device 406. The processing device 406 is operatively coupled to the communication device 402 and the memory device 406. The processing device 404 uses the communication device 402 to communicate with the network 101 and other devices on the network 101, such as, but not limited to the user device 110, the real-time interaction system 120, and the financial institution system 140. As such, the communication device 402 generally comprises a modem, server, or other device for communicating with other devices on the network 101.

As further illustrated in FIG. 4, the block chain distributed network system 130 comprises computer-readable instructions 410 stored in the memory device 406, which in one embodiment includes the computer-readable instructions 410 of a block chain application 412. In some embodiments, the memory device 406 includes data storage 408 for storing data related to the system environment, but not limited to data created and/or used by the block chain application 412.

Embodiments of the block chain distributed network system 130 may include multiple systems, servers, computers or the like maintained by one or many entities. FIG. 4 merely illustrates one of those systems that, typically, interacts with many other similar systems to form the block chain. In some embodiments, financial institution systems 140 may be part of the block chain. Similarly, in some embodiments, the block chain distributed network system 130 is part of a financial institution system 140. In other embodiments, the financial institution system 140 is distinct from the block chain distributed network system 130. The block chain distributed network system 130 may communicate with the financial institution system 140 via a secure connection generated for secure encrypted communications between the two systems.

In one embodiment of the block chain distributed network system 130 the memory device 406 stores, but is not limited to, a block chain application 412 and a distributed ledger 414. In some embodiments, the distributed ledger 414 stores data including, but not limited to, at least portions of a transaction record comprising a record of one or more real-time interactions. In one embodiment of the invention, both the block chain application 412 and the distributed ledger 414 may associate with applications having computer-executable program code that instructs the processing device 404 to operate the network communication device 402 to perform certain communication functions involving described herein. In one embodiment, the computer-executable program code of an application associated with the distributed ledger 414 and block chain application 412 may also instruct the processing device 404 to perform certain logic, data processing, and data storing functions of the application.

The processing device 404 is configured to use the communication device 402 to gather data, such as data corresponding to transactions, blocks or other updates to the distributed ledger 414 from various data sources such as other block chain network system, the real-time interaction system 120, and/or the financial institution system 140. The processing device 404 stores the data that it receives in its copy of the distributed ledger 414 stored in the memory device 406.

FIG. 5 illustrates a block diagram of a high-level real-time interaction flow environment 500, in accordance with one embodiment of the invention. In the illustrated environment, a first user 504 is associated with (i.e., a customer of) a first financial institution 502 and a second user 508 is associated with a second financial institution 506. A clearing house 510 comprises a first account 512 associated with the first financial institution 502 and a second account 514 associated with the second financial institution 506. The first account 512 and the second account 514 are accessible by each associated financial institution and the clearing house 510 which acts as a trusted intermediary during settlement between the financial institutions. Resources or funds may be transferred by each financial institution to and from their associated account. Transfers between the first account 512 and the second account 514 are administered by the clearing house 510 pending authentication and authorization by participating parties of each transfer.

In one embodiment, the first user 504 and the second user 508 are participants of a real-time interaction system, wherein the first user 504 (i.e., the payor) initiates a credit transfer to the second user 508 (i.e., the payee). In a specific example, the first user 504 is required to initiate the transfer from the first financial institution 502, wherein the first user 504 provides authentication information to authenticate the identity of the first user 504 and to validate that an account of the first user 504 held at the first financial institution 502 contains at least a sufficient amount of available funds to fulfill the transfer. While in one embodiment, the first user 504 is required to initiate the transfer from a physical, brick-and-mortar location of the first financial institution 502, in alternative embodiments described herein, the transfer may be initiated from other locations wherein a user is not required to be at a brick-and-mortar location (e.g., via an electronic application, a website, or the like).

The first user 504, as the sending participant (i.e., payor), is required to authenticate his or her identity by providing information or credentials to the associated financial institution. For example, authentication information may include account numbers, routing numbers, PIN numbers, username and password, date of birth, social security number, or the like, or other authentication information as described herein. In some embodiments, authentication may comprise multi-factor or multi-step authentication in accordance with information security standards and requirements.

Upon initiating an interaction, the first user 504 becomes obligated to pay the amount of the interaction, wherein the interaction cannot be canceled by the first user 504 following initiation and transmission of communication to a receiving participant. The second user 508, as the receiving participant (i.e., the payee), receives communication to accept payment following similar user authentication requirements. Communication between participants for the interaction is transmitted between the financial institutions via the clearing house 510 which directs the payment to the appropriate financial institution associated with the receiving participant. The transfer of funds occurs between the financial institution accounts 512 and 514 associated with the financial institutions 502 and 506 on behalf of their associated users, wherein the interaction may be settled immediately, concurrent with the interaction. As settlement occurs between the representative financial institutions, debiting and crediting of individual user accounts may be managed at each financial institution with their associated customers. As the interaction is settled immediately, funds may be made available for use in real or near real-time.

It should be understood that while the illustrated embodiment of FIG. 5 depicts only first and second users, financial institutions, and accounts, other embodiments of a real-time interaction network may comprise a plurality of accounts associated with a plurality financial institutions. In some embodiments, the environment 500 may further comprise more than one clearing house 510 (e.g., TCH, the Federal Reserve, and the like) that receive and process interaction requests as described herein. Financial institutions may include one or more community banks, regional banks, credit unions, corporate banks, direct connect financial institutions, and the like.

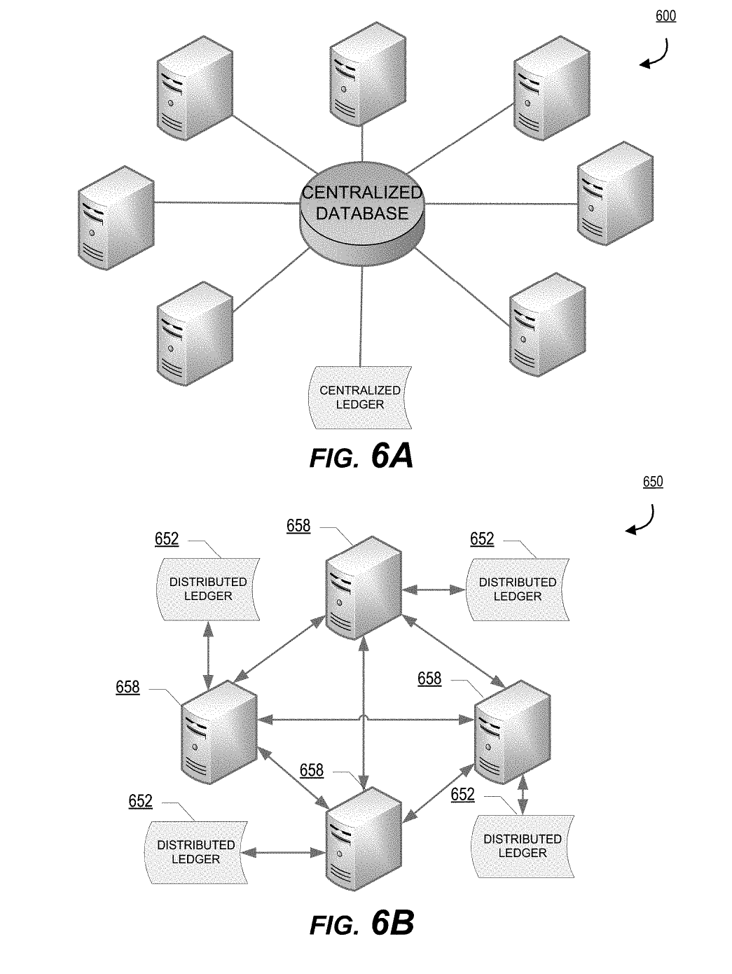

FIG. 6A illustrates a centralized database architecture environment 600, in accordance with one embodiment of the present invention. The centralized database architecture comprises multiple nodes from one or more sources and converge into a centralized database. The system, in this embodiment, may generate a single centralized ledger for data received from the various nodes. FIG. 6B provides a general block chain system environment architecture 450, in accordance with one embodiment of the present invention. Rather than utilizing a centralized database of data for instrument conversion, as discussed above in FIG. 6A, various embodiments of the invention may use a decentralized block chain configuration or architecture as shown in FIG. 6B.

A block chain is a distributed database that maintains a list of data blocks, such as real-time resource availability associated with one or more accounts or the like, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies. The data blocks recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger. As such, the status of the instrument and the resources associated therewith can be validated and cleared by one participant.

The block chain system typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person, and blocks are created by users known as “miners” who use specialized software/equipment to create blocks. In some embodiments, the block chain system is closed, as such the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases that meets other criteria.

As mentioned above and referring to FIG. 6B, a block chain system 650 is typically decentralized—meaning that a distributed ledger 652 (i.e., a decentralized ledger) is maintained on multiple nodes 658 of the block chain 650. One node in the block chain may have a complete or partial copy of the entire ledger or set of transactions and/or blocks on the block chain. Transactions are initiated at a node of a block chain and communicated to the various nodes of the block chain. Any of the nodes can validate a transaction, add the transaction to its copy of the block chain, and/or broadcast the transaction, its validation (in the form of a block) and/or other data to other nodes. This other data may include time-stamping, such as is used in cryptocurrency block chains. In some embodiments, the nodes 558 of the system might be financial institutions that function as gateways for other financial institutions. For example, a credit union might hold the account, but access the distributed system through a sponsor node.

Various other specific-purpose implementations of block chains have been developed. These include distributed domain name management, decentralized crowd-funding, synchronous/asynchronous communication, decentralized real-time ride sharing and even a general purpose deployment of decentralized applications.

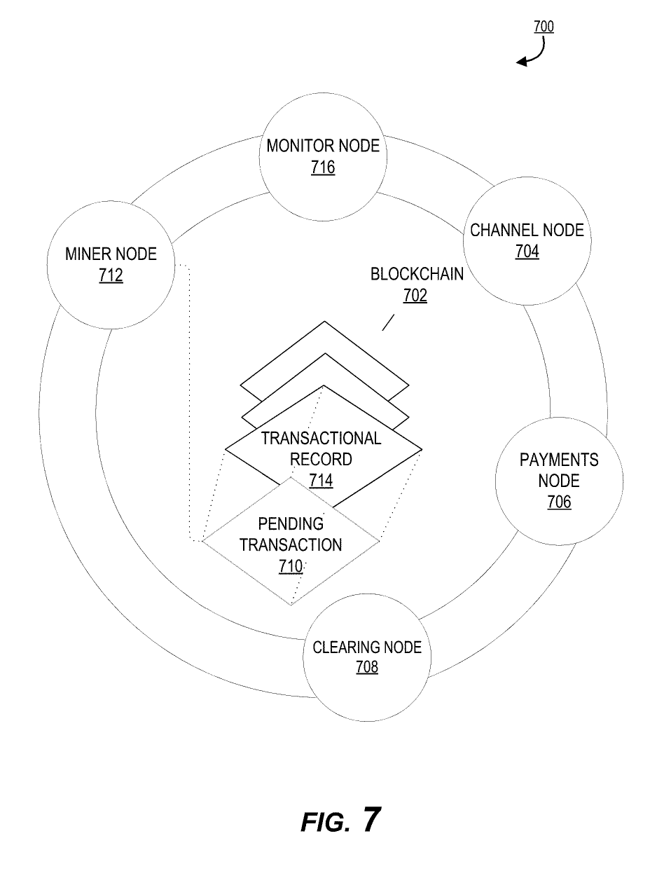

FIG. 7 provides a high level process flow illustrating node interaction within a block chain system environment architecture 700, in accordance with one embodiment of the present invention. As illustrated and discussed above, the block chain system may comprise at least one or more nodes used to generate blocks. In some embodiments, the channel node 704, payments node 706, monitor node 716 or the clearing node 708 may publish a pending transaction 710 to the block chain 702. At this stage, the transaction has not yet been validated by the miner node(s) 712, and the other nodes will delay executing their designated processes. The miner node 712 may be configured to detect a pending transaction 710. Upon verifying the integrity of the data in the pending transaction 710, the miner node 712 validates the transaction and adds the data as a transactional record 714, which is referred to as a block to the block chain 702. Once a transaction has been authenticated in this manner, the nodes will consider the transactional record 714 to be valid and thereafter execute their designated processes accordingly. The transactional record 714 will provide information about the transaction processed and transmitted through and metadata coded therein for searchability of the transactional record 714 within a distributed ledger.

In some embodiments, the system may comprise at least one additional miner node 712. The system may require that pending transactions 710 be validated by a plurality of miner nodes 712 before becoming authenticated blocks on the block chain. In some embodiments, the systems may impose a minimum threshold number of miner nodes 712 needed. The minimum threshold may be selected to strike a balance between the need for data integrity/accuracy (i.e., security/immutability) versus expediency of processing. In this way, the efficiency of the computer system resources may be maximized.

Furthermore, in some embodiments, a plurality of computer systems are in operative networked communication with one another through a network. The network may be a system specific distributive network receiving and distributing specific network feeds and identifying specific network associated triggers.

In some embodiments, the computer systems represent the nodes of the block chain, such as the miner node or the like. In such an embodiment, each of the computer systems comprise the block chain, providing for decentralized access to the block chain as well as the ability to use a consensus mechanism to verify the integrity of the data therein. In some embodiments, an upstream system and a downstream system are further operatively connected to the computer systems and each other through the network. The upstream system further comprises a ledger and the block chain. The downstream system further comprises the block chain and an internal ledger, which in turn comprises a copy of the ledger.

In some embodiments, a copy of block chain may be stored on a durable storage medium within the computer systems or the upstream system or the downstream system. In some embodiments, the durable storage medium may be RAM. In some embodiments, the durable storage medium may be a hard drive or flash drive within the system.

Smart contracts, as described herein, are computer processes that facilitate, verify and/or enforce negotiation and/or performance of a contract between parties. Smart contracts include logic that emulates contractual clauses that are partially or fully self-executing and/or self-enforcing. The smart contracts provide guidelines for transfer of data, regulation, and control of the chains within the system. The smart contracts may further define consensus (e.g., proof of work) and encryption mechanisms for the data stored in the regulatory chains. In some embodiments, cross-chain smart contracts may be configured to dynamically form one or more additional chains or relationships between one or more nodes or chains within the architecture (e.g., regulatory hyperchains). In some embodiments, one or more cross-chain smart contracts may control and enforce the movement and/or regulation of data between a plurality of block chains.

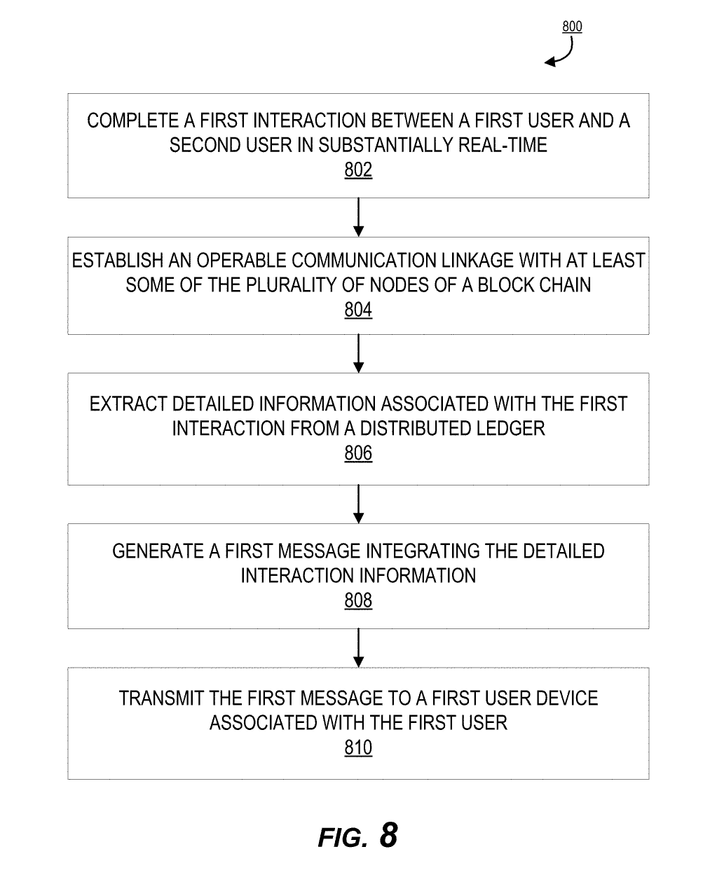

FIG. 8 provides a high level process map illustrating the implementation of a real-time interaction communication system 800, in accordance with one embodiment of the present invention. As illustrated in block 802, the process 800 is initiated by the system first completing a first interaction between a first user and a second user in substantially real-time. The first interaction may be completed by leveraging a real-time interaction system and environment as described with respect to FIG. 5 and throughout the application herein, wherein the first interaction may be settled substantially in real-time allowing for funds to be immediately made available to a receiving party following completion of the interaction. In some embodiments, the first interaction may be a transaction conducted the first user and the second user. For example, the first user may be a customer of a business of the second user, wherein the first user may purchase goods or services from the second user in exchange for a monetary resource (e.g., currency).

In some embodiments, the first interaction may be recorded on a block chain formed from a plurality of nodes as described herein. The interaction may be stored on a distributed ledger of the block chain. In some embodiments, the first interaction may be recorded on a plurality of block chains. In some embodiments, the first interaction may be recorded across one or more block chains. Due to the distributed nature of block chain architecture, details of the interaction and related historical data may be made searchable, verifiable, and visible on the block chain to a plurality of public users. In this way, a full life-cycle of an interaction may be available to the system.

As illustrated in block 804, the system establishes an operable communication linkage with the plurality of nodes of a block chain over a network. The operable communication linkage may further comprise a linkage between one or more financial institutions, clearinghouses, or the like participating in a real-time payments system environment such as the environment illustrated in FIG. 5. The system may further establish an operable communication linkage with a user device of the user, wherein the system may transmit and receive messages with the user device. In some embodiments, the communication linkage may operate according to ISO 20022 standard for electronic data interchange between financial institutions, wherein a repository of metadata stores at least a portion of messages and information transmitted over the communication linkage.

As illustrated in block 806, the system extracts detailed information associated with the first interaction stored on the distributed ledger of the block chain via the established communication linkage. Detailed information associated with an interaction may include, for example, identity information of participants of the interaction (e.g., a business name, a username, or the like), account information of one or more participants of the interaction (e.g., an account name, a name of the financial institution associated with an involved account), location information of the interaction (e.g., GPS-determined location), or the like.

In some embodiments, a user may be limited in an amount of detailed interaction information made available for viewing based on privacy concerns. In some embodiments, a user may only view detailed interaction information that is directly related to the user. For example, a user may be limited by the system to only view detailed interaction information associated with an interaction in which the user was a participant, wherein the system only makes the user's own private or secure information (e.g., account numbers, routing numbers, transaction amounts, or the like) available to the user, while similar information associated with another participant of the interaction may not be made available to the user. In some embodiments, a user may only be able to view surface-level or publicly available information associated with other participants.

In some embodiments, the system may only make available detailed interaction information or data of a predetermined privacy level determined by one or more of the users or entities participating in the interaction. A lowest tier of data may comprise completely non-critical or broad data that is available to the public which may include, for example, any information discoverable through a basic web search. Next, non-public information (NPI) may include any information obtained about an individual from a transaction such as account numbers, financial statements (e.g., credit cards, loan payments, settlements, and the like), insurance information, transactional data, bank data, or the like. Personal identifying information (PII) or sensitive personal information (SPI) may include information that can be used on its own or with other information to identify, contact, or locate a person or to identify an individual in context. PII is of higher criticality and more closely regulated than NPI. Examples of PII include social security number, date of birth, home address, home telephone number, driver's license number, biometric data (e.g., fingerprint, retinal scan, and the like). Finally, highly critical data may refer to data that exceeds the privacy/security requirements of the previous categories. Examples of highly critical data may include trade secrets, classified information, defense strategies, and the like. While only four tiers of data privacy are described herein, in some embodiments, data may be further categorized or tiered based on one or more other characteristics or predetermined rules. It should be understood that interaction information or data used in the systems and process described herein may be not limited to transactional data, but may also include other forms of data in other fields outside of financial environments. For example, health care data or records (e.g., patient records, DNA records, genomic records, and the like) may be included.

In some embodiments, the system may make available detailed interaction information for additional interactions that may be related to the first interaction. Related interactions may be other interactions recorded on the same block chain as the first interaction or interactions stored in a similar or related block chain. The system may search the records of the distributed ledger for one or more related or common tags, keywords, users, entities, metadata, or the like to identify related interactions. In some embodiments, the system may deploy a crawler script or bot on the block chain, the bot being configured to search the records of the block chain and return related results. In one example, a series of past interactions involving a particular business may all be stored on a first block chain, wherein a first user participating in a first interaction with the particular business may have access to detailed interaction information associated with the past interactions. In a specific embodiment, the system may provide a messaging system to accompany the interactions, wherein the first user may view messages (e.g., a memo, invoice, review, or the like) associated with the past transactions. In another embodiment, the system may provide information such as invoices, pricing, and the like associated with the past interactions.

In some embodiments, the system may make available to a participant of an interaction a full life-cycle of an interaction to the participant. The life-cycle may include a temporal progression of the interaction and related, past interactions as well as associated detailed information. In a specific example, a small business owner may purchase a product order from a manufacturer or supplier of the product (i.e., complete an interaction). The system may make available to the small business owner information or records related to one or more steps of production, manufacture, shipping, delivery, or the like related to the order that have been recorded on the block chain. In another specific example, the system may allow a restaurant to track purchased ingredients (i.e., “farm-to-table” tracking).

The real-time payments system of the present invention leverages block chain technology within a real-time payment infrastructure in a non-conventional way to provide both near-instant payment settlement and enhanced visibility of a life-cycle of an interaction. The system generates a holistic view of an interaction to provide to participants.

As illustrated in block 808, the system generates a first message integrating the detailed interaction information. The first message may comprise a notification of completion or settlement of an interaction between involved participants. In some embodiments, the message may comprise a notification of a request, pending, denied, or canceled interaction. The first message may further comprise a field for inclusion of notes, memos, reviews, or the like from one or more of the participants. In some embodiments, the system may incorporate at least some of the detailed interaction information with the generated message. For example, upon completion of an interaction, the system may generate a message notifying the user of the completed interaction along with a name of the other participating party, an invoice, a list of past interactions between the user and the other participating party, and the like.

In some embodiments, the system may generate and execute one or more smart contracts. Smart contracts, as described herein, are computer processes configured to facilitate, verify and/or enforce negotiation and/or performance of a contract between parties. Smart contracts include logic that emulates contractual clauses that are partially or fully self-executing and/or self-enforcing. The smart contracts provide guidelines for transfer of data, regulation, and control of the chains within the system. In some embodiments, a smart chain may be configured to complete an interaction and/or extract detailed interaction information from the distributed ledger, wherein completion of the first transaction by the smart contract is triggered by fulfillment of one or more predetermined conditions set by at least one of the first user and the second user. In some embodiments, one or more smart contracts may be configured to trigger one or more interactions in real-time based on one or more predetermined conditions or rules of the smart contract being fulfilled. For example, a smart contract may be configured to automatically complete a transaction upon completion of an interaction comprising a delivery of goods to a user.

Finally, as illustrated in block 810, the system transmits the first message to a first user device associated with the first user. In some embodiments, messages may be received by the user on a user device via a user application installed on the user device. In some embodiments, the system may provide a messaging platform to the user in the user application in which to view interaction statuses; initiate, transmit, and/or receive messages; interact with other users; view detailed interaction information; and the like.

In one embodiment, the invention may provide a project management portal to a user, wherein the portal provides a holistic view of one or more interactions of a project or business to the user (e.g., a manager or small business owner). In some embodiments, the portal may provide past, pending, and projected interactions associated with the user and the user's project or business. The system may further integrate and present extracted interaction information into the platform. In one example, the platform may present to the user a plurality of interactions recorded on the block chain associated with the user's project or business. In a specific example, the system enables the user to view individual steps or stages of a life-cycle of a product or order (e.g., manufacturing, shipping, customs processing, payment processing, delivery, etc.).

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| Docket Number | U.S. patent application Ser. No. | Title | Filed On |
|---|---|---|---|
| 8333US1.014033.3188 | To be assigned | NETWORK | Concurrently |
| | | AUTHENTICATION FOR | herewith |
| | | REAL-TIME INTERACTION | |
| | | USING PRE-AUTHORIZATED | |
| | | DATA RECORD | |
| 8334US1.014033.3189 | To be assigned | REAL-TIME NETWORK | Concurrently |
| | | PROCESSING NUCLEUS | herewith |
| 8336US1.014033.3191 | To be assigned | REAL TIME DATA | Concurrently |
| | | PROCESSING PLATFORM | herewith |
| | | FOR RESOURCES ON | |
| | | DELIVERY INTERACTIONS | |
| 8337US1.014033.3192 | To be assigned | INTERNET-OF-THINGS | Concurrently |
| | | ENABLED REAL-TIME | herewith |
| | | EVENT PROCESSING | |

What is claimed is:

1. A real-time data processing platform with integrated communication linkages, the real-time data processing platform comprising:
a controller configured for accessing and extracting information from across a distributed ledger of at least one block chain defined by a plurality of nodes participating on the at least one block chain;
a memory device with computer-readable program code stored thereon;
a communication device in communication with a network; and
a processing device operatively coupled to the memory device and the communication device, wherein the processing device is configured to execute the computer-readable program code to:
complete a first interaction between a first user and a second user in substantially real-time;
establish an operable communication linkage with at least some of the plurality of nodes of the block chain;
extract detailed interaction information associated with the first interaction from the distributed ledger;
generate a first message, wherein the detailed interaction information is integrated into the first message; and
transmit the first message to a first user device associated with the first user.

2. The real-time data processing platform of claim 1, wherein the detailed interaction information comprises information associated with a second interaction between the second user and a third user, wherein the second interaction is associated with the first interaction.

3. The real-time data processing platform of claim 1, wherein the processing device is further configured to:
execute a search of the distributed ledger for one or more additional interactions associated with the first interaction;
extract additional detailed interaction information associated with the one or more additional interactions; and
present the additional detailed information to the first user.

4. The real-time data processing platform of claim 3, wherein the additional detailed interaction information associated with the one or more additional interactions provides a full life-cycle of the one or more additional interactions, wherein the full life-cycle provides a complete temporal progression of the one or more additional interactions.

5. The real-time data processing platform of claim 4, wherein the additional detailed interaction information is extracted from across a plurality of block chains.

6. The real-time data processing platform of claim 1, wherein the detailed interaction information comprises location information associated with the first interaction.

7. The real-time data processing platform of claim 1, wherein at least one smart contract is configured to complete the first interaction and extract the detailed interaction information from the distributed ledger, wherein completion of the first interaction by the smart contract is triggered by fulfillment of one or more predetermined conditions set by at least one of the first user and the second user.

8. A computer program product for providing a real-time data processing platform with integrated communication linkages, wherein the computer program product comprises at least one non-transitory computer readable medium comprising computer readable instructions, the computer readable instructions, when executed by a computer processor, cause the computer processor to:
complete a first interaction between a first user and a second user in substantially real-time;
establish an operable communication linkage with at least some of a plurality of nodes, the plurality of nodes defining at least one block chain comprising a distributed ledger of the at least one block chain;
extract detailed interaction information associated with the first interaction from the distributed ledger;
generate a first message, wherein the detailed interaction information is integrated into the first message; and
transmit the first message to a first user device associated with the first user.

9. The computer program product of claim 8, wherein the detailed interaction information comprises information associated with a second interaction between the second user and a third user, wherein the second interaction is associated with the first interaction.

10. The computer program product of claim 8, wherein the computer-readable instructions further cause the computer processor to:
execute a search of the distributed ledger for one or more additional interactions associated with the first interaction;
extract additional detailed interaction information associated with the one or more additional interactions; and
present the additional detailed information to the first user.

11. The computer program product of claim 10, wherein the additional detailed interaction information associated with the one or more additional interactions provides a full life-cycle of the one or more additional interactions, wherein the full life-cycle provides a complete temporal progression of the one or more additional interactions.

12. The computer program product of claim 11, wherein the additional detailed interaction information is extracted from across a plurality of block chains.

13. The computer program product of claim 8, wherein the detailed interaction information comprises location information associated with the first interaction.

14. The computer program product of claim 8, wherein at least one smart contract is configured to complete the first interaction and extract the detailed interaction information from the distributed ledger, wherein completion of the first interaction by the smart contract is triggered by fulfillment of one or more predetermined conditions set by at least one of the first user and the second user.

15. A computer-implemented method for providing a real-time data processing platform with integrated communication linkages, the computer-implemented method comprising:
completing a first interaction between a first user and a second user in substantially real-time;
establishing an operable communication linkage with at least some of a plurality of nodes, the plurality of nodes defining at least one block chain comprising a distributed ledger of the at least one block chain;
extracting detailed interaction information associated with the first interaction from the distributed ledger;
generating a first message, wherein the detailed interaction information is integrated into the first message; and
transmitting the first message to a first user device associated with the first user.

16. The computer-implemented method of claim 15, wherein the detailed interaction information comprises information associated with a second interaction between the second user and a third user, wherein the second interaction is associated with the first interaction.

17. The computer-implemented method of claim 15, further comprising:
executing a search of the distributed ledger for one or more additional interactions associated with the first interaction;
extracting additional detailed interaction information associated with the one or more additional interactions; and
presenting the additional detailed information to the first user.

18. The computer-implemented method of claim 17, wherein the additional detailed interaction information associated with the one or more additional interactions provides a full life-cycle of the one or more additional interactions, wherein the full life-cycle provides a complete temporal progression of the one or more additional interactions.

19. The computer-implemented method of claim 18, wherein the additional detailed interaction information is extracted from across a plurality of block chains.

20. The computer-implemented method of claim 15, wherein the detailed interaction information comprises location information associated with the first interaction.
